(19) United States
(12) Patent Application Publication
(10) Pub. No.: US 2025/0390168 A1
(43) Pub. Date: Dec. 25, 2025

(54) IN-APPLICATION EYE-TRACKING CALIBRATION

(71) Applicant: QUALCOMM Incorporated, San Diego, CA (US)

(72) Inventors: Tanu SHARMA, Najafgarh (IN); Sriram AJAYKUMAR, Bangalore (IN); Nikhil KRISHNAN, Bangalore (IN); Vinay MELKOTE KRISHNAPRASAD, Bangalore (IN)

(21) Appl. No.: 18/752,632

(22) Filed: Jun. 24, 2024

(51) Int. Cl. G06F 3/01; G06F 3/14

(52) U.S. Cl. CPC G06F 3/013; G06F 3/012; G06F 3/14

(57) ABSTRACT

This disclosure provides systems, devices, apparatus, and methods, including computer programs encoded on storage media, for calibrating eye-tracking within an application. A display processor may execute an application that displays a first scene to a display. While the application is executed, the display processor may (a) receive a set of eye focus data associated with an eye focus of a user, (b) display a calibration indicator to the display, (c) receive a calibration feedback from the user comprising an error correction indicator based on the displayed calibration indicator, (d) adjust a calibration of the display relative to the set of eye focus data based on the error correction indicator, and (e) display a second scene to the display based on the adjusted calibration of the display and the set of eye focus data.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address dynamic errors and inaccuracies in eye-focus calibration. There is a need for improved eye-focus calibration that can dynamically and rapidly recalibrate a display when calibration errors are introduced.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor may be configured to: execute an application that displays a first scene to a display, for example a left-eye display or a right-eye display of a head-mounted unit (HMU). While the application is executed, the processor may be configured to receive a set of eye focus data associated with an eye focus of a user. While the application is executed, the processor may be configured to display a calibration indicator to the display. While the application is executed, the processor may be configured to receive a calibration feedback from the user including an error correction indicator based on the displayed calibration indicator. While the application is executed, the processor may be configured to adjust a calibration of the display relative to the set of eye focus data based on the error correction indicator. While the application is executed, the processor may be configured to display a second scene to the display based on the adjusted calibration of the display and the set of eye focus data.

In some aspects, the techniques described herein relate to a method of display processing, including: executing an application that displays a first scene to a display, where, while the application is executed, the method further includes: receiving a set of eye focus data associated with an eye focus of a user; displaying a calibration indicator to the display; receiving a calibration feedback from the user including an error correction indicator based on the displayed calibration indicator; adjusting a calibration of the display relative to the set of eye focus data based on the error correction indicator; and displaying a second scene to the display based on the adjusted calibration of the display and the set of eye focus data.

In some aspects, the techniques described herein relate to a method, where receiving the set of eye focus data includes: receiving a set of sensor data from a set of sensors monitoring the user.

In some aspects, the techniques described herein relate to a method, where the set of sensors includes at least one of: a head pose sensor; and an eye focus sensor.

In some aspects, the techniques described herein relate to a method, further including: estimating the eye focus based on the set of eye focus data.

In some aspects, the techniques described herein relate to a method, where the first scene includes an outer quad (OQ) area and an inner quad (IQ) area, where the IQ area has a higher pixel per degree (PPD) than the OQ area, where displaying the calibration indicator to the display includes: centering the IQ area on the estimated eye focus.

In some aspects, the techniques described herein relate to a method, where the OQ area has a wider field of view (FOV) than the IQ area.

In some aspects, the techniques described herein relate to a method, where the error correction indicator includes a vertical scale factor from the user and a horizontal scale factor.

In some aspects, the techniques described herein relate to a method, where adjusting the calibration of the display relative to the set of eye focus data based on the error correction indicator includes: determining a modified horizontal direction based on the horizontal scale factor; determining a modified vertical direction based on the vertical scale factor; and determining an adjusted eye focus based on the determined modified horizontal direction and the determined modified vertical direction.

In some aspects, the techniques described herein relate to a method, where adjusting the calibration of the display relative to the set of eye focus data based on the error correction indicator further includes: normalizing the adjusted eye focus further to have a unit norm based on the determined modified horizontal direction and the determined modified vertical direction.

In some aspects, the techniques described herein relate to a method, where the second scene includes an outer quad (OQ) area and an inner quad (IQ) area, where the IQ area has a higher pixel per degree (PPD) than the OQ area, where displaying the second scene to the display based on the adjusted calibration of the display and the set of eye focus data includes: centering the IQ area on the determined adjusted eye focus.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example display framework including a display processor and a display in accordance with one or more techniques of this disclosure.

FIG. 3 illustrates an example of a server and a client configured to render multiple views for a display, in accordance with one or more techniques of this disclosure.

FIG. 4 illustrates an example of a calibration indicator used to calibrating a display, in accordance with one or more techniques of this disclosure.

FIG. 5 is a flowchart of an example method of display processing, in accordance with one or more techniques of this disclosure.

FIG. 6 is a call flow diagram illustrating example communications between a CPU, an application, and a display, in accordance with one or more techniques of this disclosure.

FIG. 7 is a flowchart of an example method of display processing, in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to calibration of a display. Some aspects more specifically relate to eye-tracking calibration for a display using a sensor that tracks the eye focus of a user. Such a display may include a head-mounted display (HMD) for a head-mounted unit (HMU). An HMU may have two HMDs, one for each eye of the user. In some aspects, an HMU may have a single HMD that is split into two isolated sections by a partition, allowing one eye to look at a first portion of the display and a second eye to look at a second portion of the same display. An HMU may have a set of sensors that track the focus of each eye of the user associated with the set of HMDs, and outputs eye focus data. The eye focus data may include, for example, an origin and a vector of an eye gaze. The eye focus data may include an indicator of a direction that an eye is looking, or a point on a display in front of the eye that the eye is estimated to be focusing on. A display processor may be configured to display an image based on eye focus data, for example by rendering an area of an image with a high number of pixels per degree (PPD) near the area that an eye is focused, and rendering an area of an image with a low number of PPD that is further from the area that the eye is focused. A display may be calibrated with an eye-tracking sensor to optimize such rendering techniques. However, the calibration of a display with an eye-tracking sensor may become inaccurate over time, for example if a human user readjusts their HMU, or if glasses that the user is wearing shifts in position.

In some examples, a display calibration adjuster may execute an application that displays a first scene to a display. The application may be, for example, a virtual reality (VR) application or an extended reality (XR) application designed to display a virtual environment to the eyes of a user via a plurality of displays or a display with a partition between sides of the display. The application may be an on-device application that is not split and runs fully on the device, where the user of the device may provide input via a set of controllers connected to the device, or via buttons on the device. While the application is executed, the display calibration adjuster may receive a set of eye focus data associated with an eye focus of a user. The eye focus data may be received from a set of sensors that monitor a head pose of a user, and an eye gaze of each of the eyes of the user. Each eye may be associated with a display of a scene, for example a left scene for a left-eye of the user and a right scene for a right-eye of the user. While the application is executed, the display calibration adjuster may display a calibration indicator to the display. The calibration indicator may be, for example, a focused feature on the display. The focused feature may be centered on a calculated eye gaze of the user based on the eye focus data previously received by the display calibration adjuster. While the application is executed, the display calibration adjuster may receive a calibration feedback from the user including an error correction indicator based on the displayed calibration indicator. The calibration feedback may be received via a user interface (UI), for example a keyboard, a joystick, a pad, or a microphone. The error correction indicator may include, for example, a horizontal offset and a vertical offset, or a horizontal scale factor and a vertical scale factor. While the application is executed, the display calibration adjuster may adjust a calibration of the display relative to the set of eye focus data based on the error correction indicator. While the application is executed, the display calibration adjuster may display a second scene to the display based on the adjusted calibration of the display and the set of eye focus data.

Particular aspects of the subject matter described in this disclosure can be implemented to realize one or more of the following potential advantages. In some examples, by dynamically calibrating eye focus data from a sensor with eye focus display techniques using user-input calibration feedback within an application, the described techniques can be used to better align visual feedback on where an eye tracker calculates an eye focus vs. where the eye is actually focusing. Eye focus display techniques may include, for example, quad view designs (e.g., designs that render two views per eye for composited display outputs).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

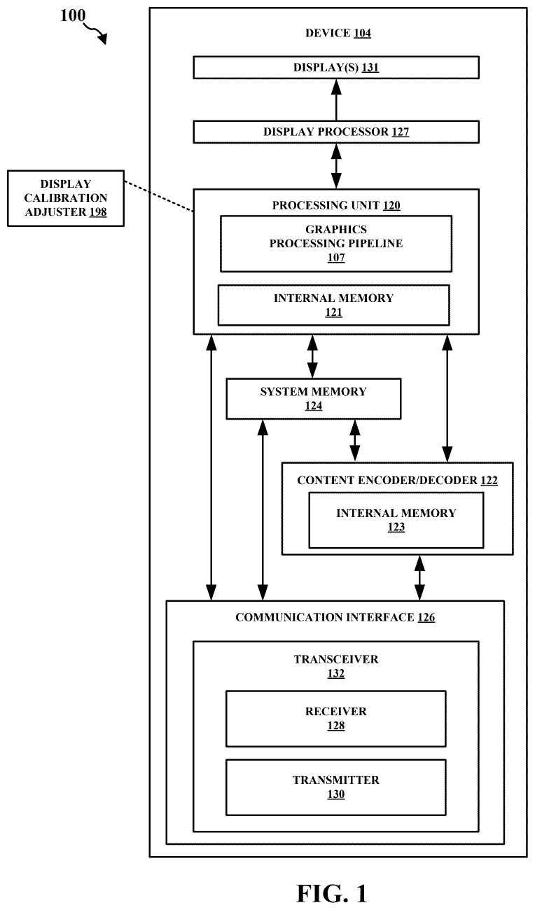

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and a set of displays 131). The set of displays 131 may refer to one or more displays. For example, the set of displays 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the set of displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The set of displays 131 may be configured to display or otherwise present frames processed by the display processor 127. In some examples, the set of displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a display calibration adjuster 198 configured to display calibration adjuster 198. While the application is executed, the display calibration adjuster 198 may receive a set of eye focus data associated with an eye focus of a user. While the application is executed, the display calibration adjuster 198 may display a calibration indicator to the display. While the application is executed, the display calibration adjuster 198 may receive a calibration feedback from the user including an error correction indicator based on the displayed calibration indicator. While the application is executed, the display calibration adjuster 198 may adjust a calibration of the display relative to the set of eye focus data based on the error correction indicator. While the application is executed, the display calibration adjuster 198 may display a second scene to the display based on the adjusted calibration of the display and the set of eye focus data. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

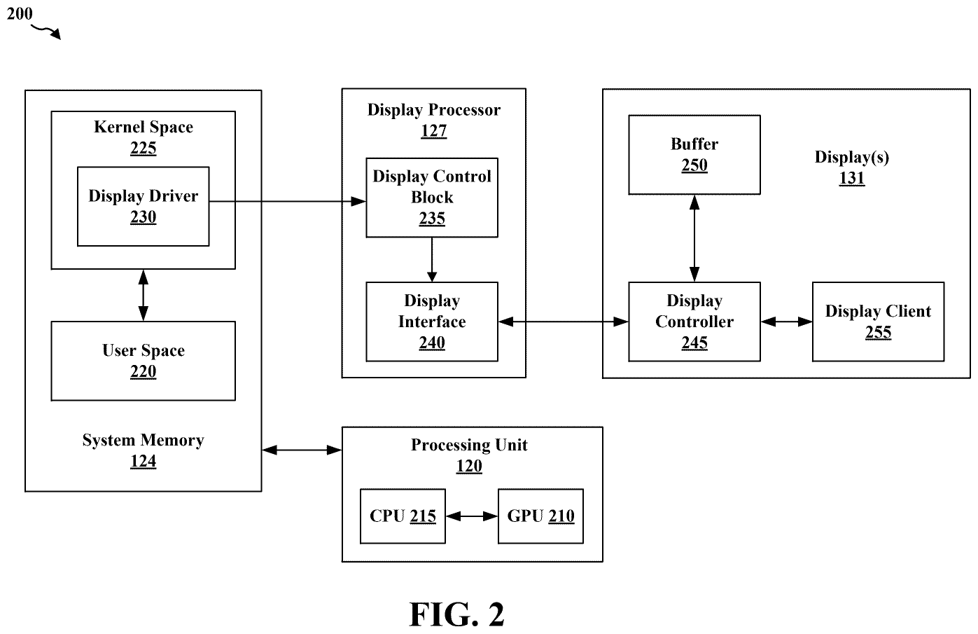

FIG. 2 is a block diagram 200 that illustrates an example display framework including the processing unit 120, the system memory 124, the display processor 127, and the set of displays 131, as may be identified in connection with the device 104.

A GPU may be included in devices that provide content for visual presentation on a display. For example, the processing unit 120 may include a GPU 210 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 210 may be controlled based on one or more graphics processing commands provided by a CPU 215. The CPU 215 may be configured to execute multiple applications concurrently. In some cases, each of the concurrently executed multiple applications may utilize the GPU 210 simultaneously. Processing techniques may be performed via the processing unit 120 output a frame over physical or wireless communication channels.

The system memory 124, which may be executed by the processing unit 120, may include a user space 220 and a kernel space 225. The user space 220 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 225 may further include a display driver 230. The display driver 230 may be configured to control the display processor 127. For example, the display driver 230 may cause the display processor 127 to compose a frame and transmit the data for the frame to a display.

The display processor 127 includes a display control block 235 and a display interface 240. The display processor 127 may be configured to manipulate functions of the set of displays 131 (e.g., based on an input received from the display driver 230). The display control block 235 may be further configured to output image frames to the set of displays 131 via the display interface 240. In some examples, the display control block 235 may additionally or alternatively perform post-processing of image data provided based on execution of the system memory 124 by the processing unit 120.

The display interface 240 may be configured to cause the set of displays 131 to display image frames. The display interface 240 may output image data to the set of displays 131 according to an interface protocol, such as, for example, the MIPI DSI (Mobile Industry Processor Interface, Display Serial Interface). That is, the set of displays 131, may be configured in accordance with MIPI DSI standards. The MIPI DSI standard supports a video mode and a command mode. In examples where the set of displays 131 is/are operating in video mode, the display processor 127 may continuously refresh the graphical content of the set of displays 131. For example, the entire graphical content may be refreshed per refresh cycle (e.g., line-by-line). In examples where the set of displays 131 is/are operating in command mode, the display processor 127 may write the graphical content of a frame to a buffer 250.

In some such examples, the display processor 127 may not continuously refresh the graphical content of the set of displays 131. Instead, the display processor 127 may use a vertical synchronization (Vsync) pulse to coordinate rendering and consuming of graphical content at the buffer 250. For example, when a Vsync pulse is generated, the display processor 127 may output new graphical content to the buffer 250. Thus, generation of the Vsync pulse may indicate that current graphical content has been rendered at the buffer 250.

Frames are displayed at the set of displays 131 based on a display controller 245, a display client 255, and the buffer 250. The display controller 245 may receive image data from the display interface 240 and store the received image data in the buffer 250. In some examples, the display controller 245 may output the image data stored in the buffer 250 to the display client 255. Thus, the buffer 250 may represent a local memory to the set of displays 131. In some examples, the display controller 245 may output the image data received from the display interface 240 directly to the display client 255.

The display client 255 may be associated with a touch panel that senses interactions between a user and the set of displays 131. As the user interacts with the set of displays 131, one or more sensors in the touch panel may output signals to the display controller 245 that indicate which of the one or more sensors have sensor activity, a duration of the sensor activity, an applied pressure to the one or more sensor, etc. The display controller 245 may use the sensor outputs to determine a manner in which the user has interacted with the set of displays 131. The set of displays 131 may be further associated with/include other devices, such as a camera, a microphone, and/or a speaker, that operate in connection with the display client 255.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 210 may process a content buffer based on execution of an application that generates content on a pixel-by-pixel basis. During the composition and display stage(s), pixel elements may be assembled to form a frame that is transferred to a physical display panel/subsystem (e.g., the set of displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

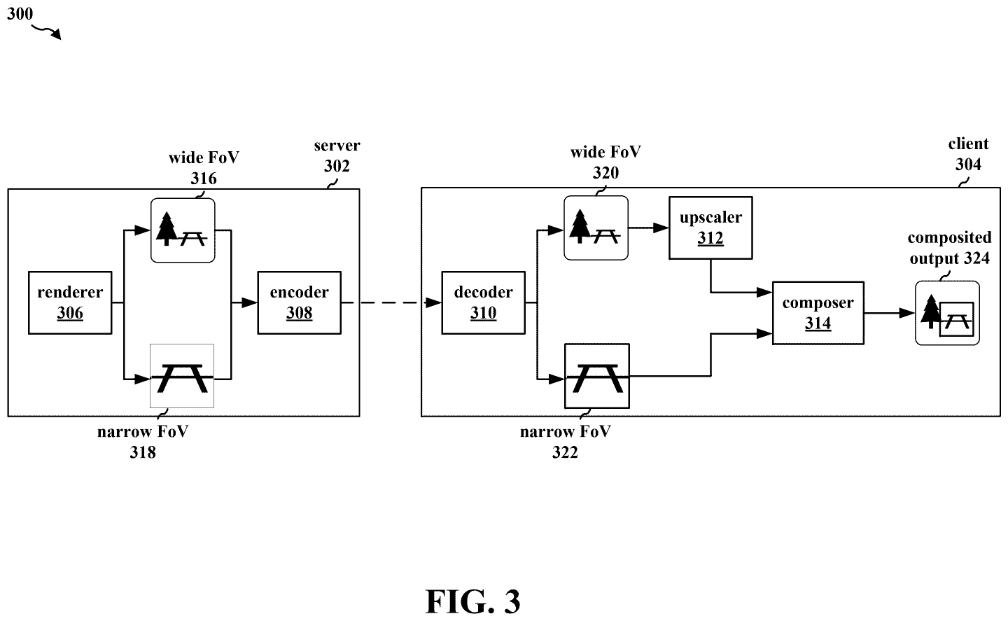

FIG. 3 is a diagram 300 that illustrates an exemplary eye focus technique employed by a server and a client configured to render multiple views for a display. The eye focus technique may include a quad view design that exploits the fact that the human eye perceives high resolution in a narrow fovea. A quad view design may render two views, or frames, per eye, or four views in total. The quad view design may render a wide field of view (FoV) outer quad (OQ) with a low pixels per degree (PPD) and a narrow FoV inner quad (IQ) with a high PPD. The wide FoV may be based on a head pose of the user, and the narrow FoV may be based on the head pose and the eye focus of the wearer. The narrow FOV may also be referred to as a foveal view. In some aspects, a display system may track the eye gaze of a user to ensure that the IQ with the narrow FoV is centered at the eye gaze of the user, providing the user with a virtualized high resolution image, even if the entire image is not rendered at a high PPD.

A server 302 may be used to render a plurality of frames for a client 304, which outputs a composited output to a display. The server 302 may be, for example, a computer device (e.g., a desktop, a mobile device) with a GPU that renders frames, and the client 304 may be, for example, an HMU that a user that displays two views-one for each eye of the user. While diagram 300 illustrates a server 302 and a client 304 working together to generate a composited output for a display, in other aspects a single device may be used to both render a plurality of frames and generate a composited output for a display.

The server 302 may have a renderer 306 that renders two frames for a display, a wide FoV 316 and a narrow FoV 318. The narrow FoV 318 may have a first PPD that is higher than a second PPD of the wide FoV 316. For example, the wide FoV 316 may have a 1.8 k×1.8 k resolution over a 60-degree range, and the narrow FoV may have a 1.8 k×1.8 k resolution over a 30-degree range. An encoder 308 may encode the wide FoV 316 and the narrow FoV 318. The server 302 may transmit the encoded FoVs to the client 304, for example via a wired or a wireless interface connection. The decoder 310 may decode the FoVs to generate the wide FoV 320, which may be a decoded version of the wide FoV 316, and the decoder 310 may decode the FoVs to generate the narrow FoV 322, which may be a decoded version of the narrow FoV 318. An upscaler 312 may upscale the wide FoV 320 to improve the PPD of the wide FoV 320, and the composer 314 may composite the upscaled frame of the wide FoV 320 from the upscaler 312 with the narrow FoV 322 to generate a composited output 324. The composited output 324 may be displayed on a display to an eye of a user.

The renderer 306 may be configured to render the narrow FOV about a focus area of an eye of a user. The server 302 may receive an indicator of a head pose of a user and an indicator of an eye focus of the user to determine where the user is focusing. The server 302 may center an IQ about the calculated eye focus, and the renderer 306 may be configured to render the narrow FoV about the IQ, ensuring that the area where the user focuses has a high resolution in the narrow fovea of the user. This allows the user to experience a virtualized high PPD display, even if the entire display is not rendered at a high PPD by the renderer 306.

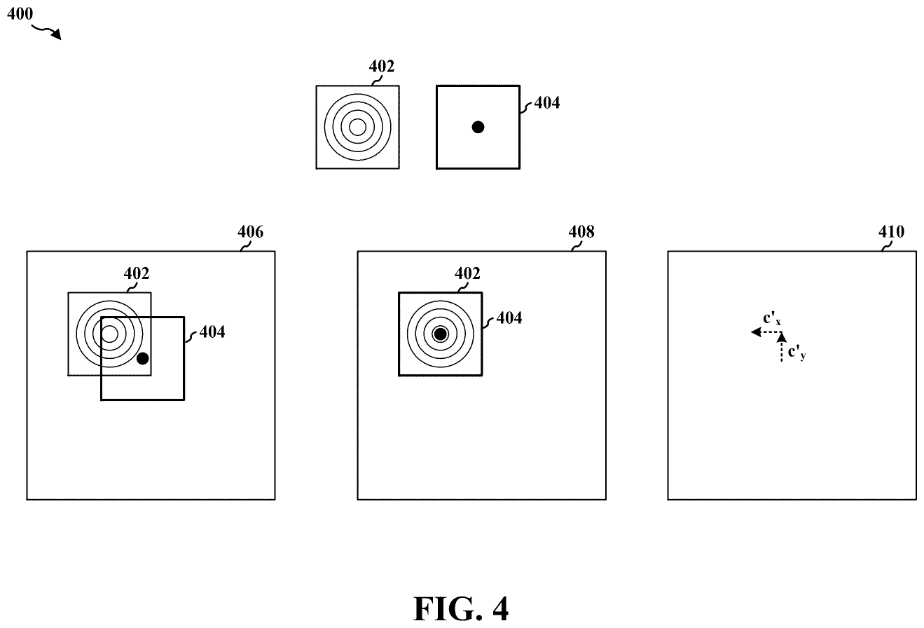

FIG. 4 is a diagram 400 that illustrates an example of a set of calibration indicators for calibrating a display. A display calibration adjuster may be configured to display a focused feature 402 on a display 406. The display calibration adjuster may be configured to display the focused feature 402 based on a set of eye focus data associated with an eye focus of a user. For example, a sensor, such as an eye focus sensor, may be aimed at an eye of the user. The eye focus sensor may calculate an eye focus in terms of an eye gaze vector, such as (x, y, z), where x²+y²+z²=1. The display calibration adjuster may center the focused feature 402 based on the calculated (x, y, z) based on eye focus data from the eye focus sensor.

The focused feature 402 may not be aligned with an eye of the user. For example, the user may not have correctly calibrated a lens distortion correction (LDC) system or a chromatic aberration correction (CRC) system based on the user's eye-position relative to the display. In another example, the user may have readjusted an HMU after an initial eye-gaze calibration by the user, which may lead to errors in one or both components of gaze directions. In another example, the user may remove and remount an HMU before or during a split extended reality (XR) experience, introducing an offset error. In another example, internal reflections off of a user's eye glasses may occlude the eye-image in a camera, or may distort an LDC technique. In another example, a user may wear glasses during a calibration and may remove the glasses after calibration. The actual gaze of the user may be represented by the gaze 404, which is offset from the focused feature 402 calculated by the user's eye focus data. In other words, the focused feature 402 may represent where the eye-tracker calculates the user is looking, and the gaze 404 may represent where the user is actually looking on the display.

The user may observe the calibration error by focusing on the center of the focused feature 402. The focused feature may include a target or a series of concentric circles to allow the user to focus on a center of the focused feature. If the eye-tracker is not calibrated correctly, the focused feature 402 may move across the display 406 as the user attempts to focus on the center of the focused feature, but the inaccuracy in calibration may cause the focused feature 402 to move across the screen as the user attempts to focus on the center of the focused feature 402. The user may provide key-based input, for example via a suitable user interface (UI) (e.g., a keyboard, a series of button clicks, a verbal command), which may increment or decrement a scale that is to be multiplied with the angles of x and y components of the eye gaze region. The display 408 may represent a calibrated display where the gaze 404 of the user aligns with the focused feature 402 on the display 408. Display 410 indicates the user input that is applied to align the focused feature 402 with the gaze 404 of the user. The new scale factor input by the user may be represented by (cₓ′, c_{y}′), where cₓ′ represents a scale offset in a horizontal direction, and c_{y}′ represents a scale offset in a vertical direction. In other words, (cₓ′, c_{y}′) may represent an error correction indicator received by a user, where cₓ′ represents a horizontal scale factor and c_{y}′ represents a vertical scale factor. The scale factor may be used to calculate a new, calibrated, eye gaze direction (x′, y′, z′) of the user, where x′²+y′²+z′²=1.

In some aspects, the error correction indicator may be used to calculate a modified horizontal direction and a modified vertical direction. For example, the display calibration adjuster may calculate a modified horizontal direction based on the horizontal scale factor as

$$x \hat{}= tan ( {tan}^{- 1} ( \frac{x}{z} ) * {{c}^{′}}_{x} ) ,$$

where x\hat{ } is the modified horizontal direction. In another example, the display calibration adjuster may calculate a modified vertical direction based on the vertical scale factor as

$$y \hat{}= tan ( {tan}^{- 1} ( \frac{y}{z} ) * {{c}^{′}}_{y} ) ,$$

where y\hat{ } is the modified vertical direction. A scale factor, or magnitude, may be calculated based on both the calculated modified horizontal direction and the calculated modified vertical direction. For example, a scale factor, or magnitude, may be calculated as m=\sqrt{(x\hat{ })²+(y\hat{ })²+z²}, where m is the calculated magnitude. The new, calibrated, eye gaze direction (x′, y′, z′) may then be calculated as

$${x}^{′} = \frac{x \hat{}}{m} , {y}^{′} = \frac{y \hat{}}{m} , {z}^{′} = \frac{z}{m}$$

based on the previous calculations. The calibrated eye gaze direction (x′, y′, z′) may be used to ensure that the focused feature 402 aligns with the gaze 404 of the user. The calibrated eye gaze direction (x′, y′, z′) may be used to calculate a center of an IQ of a rendered quad view based design, or may be used in another eye focus display technique.

While FIG. 4 shows a single display, a display calibration adjuster may perform a calibration synchronously or asynchronously for each display of a device, for example a left-eye display of an HMU and a right-eye display of an HMU. In other words, the display calibration adjuster may perform a calibration for a right-eye display first, and a left-eye display second, may perform a calibration for a right-eye display independently from a calibration for a left-eye display, or may perform a calibration for both eyes at the same time, where the gaze 404 of the user is tracked for both displays simultaneously.

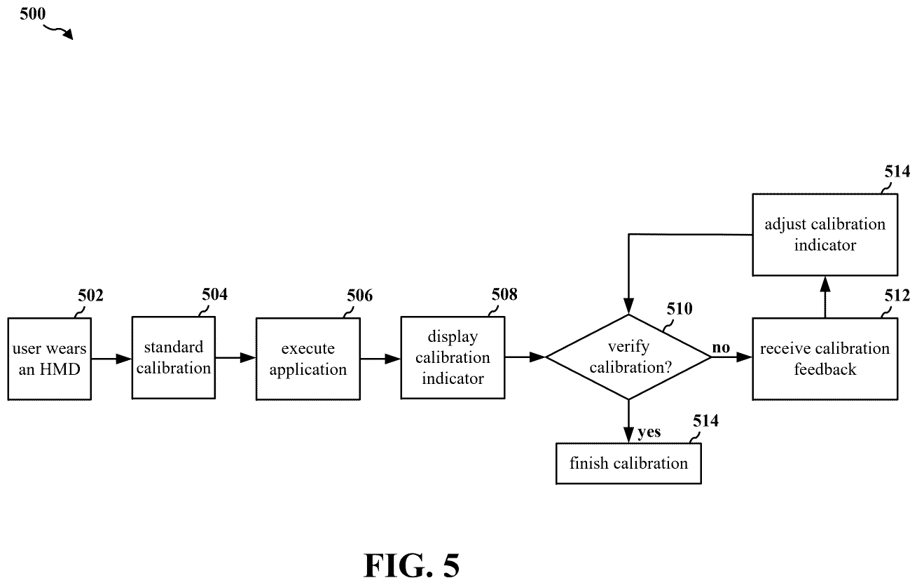

FIG. 5 is a flowchart 500 of an example method of display processing, in accordance with one or more techniques of this disclosure. At 502, a user may wear an HMU. The HMU may have a set of HMDs for the eyes of a user, a head pose sensor, and an eye focus sensor for each eye. The eye focus data for each eye may be used to track where the eye is focusing on for the display.

At 504, the user may activate a standard calibration for the HMU. The calibration may use a standalone app, for example a system calibration setting. The standard calibration may include, for example analyzing a gaze of the user to calculate where the user is looking on a display. The standard calibration may include displaying an icon on the display and instructing the user to look at the icon in designated periods of time as the icon moves about the display to calculate where the user is looking. The standard calibration may not include calibration feedback as a horizontal and/or vertical offset.

At 506 the user may execute an application on the HMU. The executed application may include, for example, an XR app, or a rendered virtual reality (RVR) client and server. While the app is executed, a display calibration adjuster may enable the user to modify base eye-tracking input to better align visual feedback on where the eye-tracker believes the user is looking compared to where the eye is actually looking. For example, when a user observes a calibration error, an input may be provided to increment or decrement a scale to adjust the gaze direction to the focus area of the use.

At 508, the display calibration adjuster may display a calibration indicator centered on a calculated IQ area of a display. The display calibration adjuster may display the calibration indicator on both displays, or just one display at a time. At 510, the user may verify whether the displayed calibration indicator is displayed at the center of where the user is actually looking, or if the displayed calibration indicator is offset by some amount. If the user does not think the displayed calibration indicator is aligned with the user's gaze, at 512 the user may indicate calibration feedback to the display calibration adjuster via a UI. For example, the user may press up and down keys to adjust a vertical offset, or may press left and right keys to adjust a horizontal offset. At 514, the display calibration adjuster may adjust the location of where the calibration indicator is displayed based on the received feedback, and at 510 the user may then, again, verify whether the displayed calibration indicator is displayed at the center of where the user is actually looking, or if the displayed calibration indicator is offset by some amount.

At some point, the user may indicate that the displayed calibration indicator id displayed at the center of where the user is actually looking. At 514, the display calibration adjuster may finish calibration and base future eye focus calculations (e.g., (x′, y′, z′)) on the calibration feedback (e.g., (cₓ′, c_{y}′)) from the user.

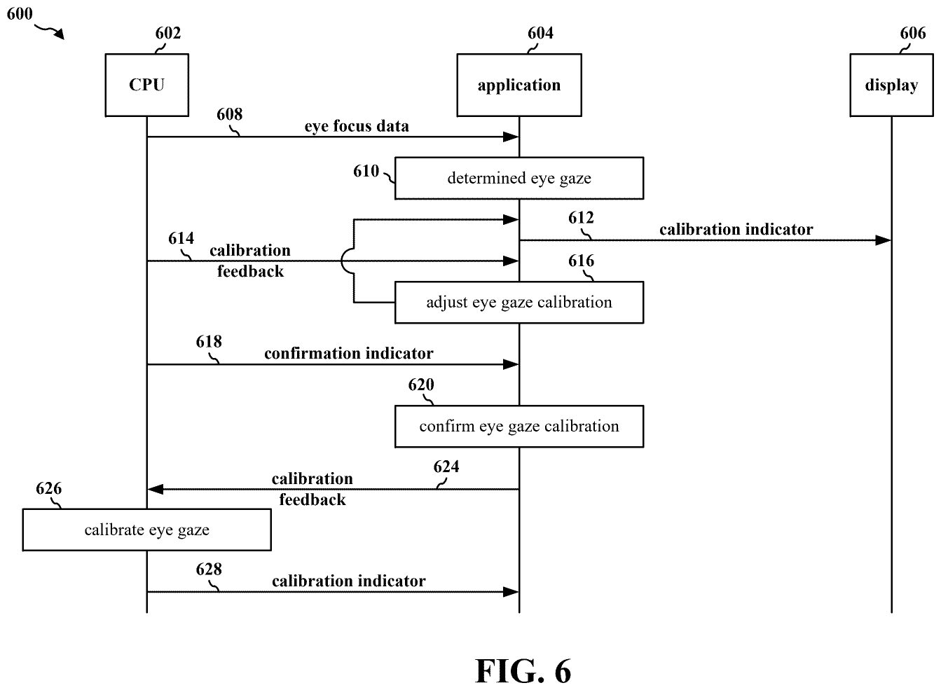

FIG. 6 is a call flow diagram 600 illustrating example communications between a CPU 602, an application 604, and a display 606, in accordance with one or more techniques of this disclosure. The CPU 602 may be a CPU in an HMU that communicates with a user interface of the HMU, for example joysticks or buttons on a mobile device. The CPU 602 may be a system that controls the application 604. The application 604 may execute on the system, and may transmit instructions to the display 606. The display 606 may be an HMD, or a set of HMDs for the HMU. The display 606 may be a display processing unit (DPU) that controls a display, such as an HMD, a set of HMDs for an HMU. The display 606 may be configured to display a set of images to one eye of a user of the HMU, or to both eyes of the user of the HMU.

The CPU 602 may transmit an indicator of a set of eye focus data 608 to the application 604. The application 604 may receive the indicator of the set of eye focus data 608 from the CPU. The set of eye focus data 608 may include head pose data and/or eye focus data. The set of eye focus data 608 may include, for example, head pose data from a head pose sensor that senses a head pose of the user. The set of eye focus data 608 may include, for example, an estimate of an eye gaze direction or vector for one or both eyes of the user. In some aspects, the CPU 602 may be configured to periodically transmit indicators of the set of eye focus data 608 to the application 604, for example every 10 milliseconds (ms) or every 100 ms. In some aspects, the CPU 602 may not transmit head pose data at the same frequency or period as the eye gaze data.

At 610, the application 604 may determine the eye gaze of the user based on the set of eye focus data 608. For example, the application 604 may calculate an eye gaze (x, y, z), where, x²+y²+z²=1 based on a system calibration for the user. For example, before the application 604 is opened, the user may use a system calibration to calibrate determination of the user's eye gaze. For example, the system calibration may periodically display images on a set of HMDs of the HMU, and instruct the user to look at the displayed images. The system calibration may estimate where the user is looking based on head pose sensor data, eye gaze sensor data, and a location of where the images are displayed on the set of HMDs. When the application 604 is opened, the application 604 may then use the head pose sensor data and eye gaze sensor data to determine a set of eye gaze coordinates (e.g., (x, y, z)) of the user. When the application 604 wishes to perform an in-app calibration for the user (e.g., if the user moves the HMU or the user transmits an instruction to the app to execute an in-app calibration process), the application 604 may be configured to display a calibration indicator to at least one display portion (e.g., a display portion for a left-eye or a right-eye of the user) of the display 606. The application 604 may center the calibration indicator 612, such as a focused feature, based on the calculated eye gaze (e.g., center the focused feature on the determined eye gaze coordinates). In some aspects, where the display 606 includes a first display portion for a left-eye of the user and a second display portion for a right-eye of the user, the calibration indicator 612 may center the calibration indicator 612 on the display portion that corresponds with one determined eye gaze of the user (e.g., the right-eye for a display portion corresponding with the user's right-eye or the left-eye for the other display portion), allowing the application 604 to calibrate one eye of the user at a time. In other aspects, the calibration indicator 612 may center a first calibration indicator on a first display portion based on a first determined eye gaze for a first eye of the user, and a second calibration indicator on a second display portion based on a second determined eye gaze for a second eye of the user at the same time. While such calibration may not be as accurate as a calibration for each eye individually, such a calibration may be performed more rapidly than single-eye calibration. The application 604 may output an indication of a calibration indicator 612 to the display 606 based on the eye gaze direction(s) determined a 610. The display 606 may receive the indication of the calibration indicator 612 from the application 604. In response, the display 606 may display the calibration indicator 612 to a display portion of the display 606 centered on the determined set of eye gaze coordinates. The calibration indicator 612 may include a focused feature centered on the eye gaze determined at 610.

A user may view the calibration indicator and may realize that the calibration indicator is not aligned with the actual gaze of the user. The user may provide calibration feedback to the CPU 602, for example via a UI. The calibration feedback may include a set of offsets, for example vertical and horizontal offsets. The CPU 602 may transmit an indicator of the calibration feedback 614 to the application 604. The application 604 may receive the indicator of the calibration feedback 614 from the CPU 602. At 616, the application 604 may adjust its eye gaze calibration based on the calibration feedback 614. For example, the calibration feedback may include an error correction indicator (cₓ′, c_{y}′), and the application 604 may calculate a new eye gaze direction (x′, y′, z′) based on the calibration feedback, for example by determining the new eye gaze direction as

$${x}^{′} = \frac{x \hat{}}{m} , {y}^{′} = \frac{y \hat{}}{m} , {z}^{′} = \frac{z}{m}$$

based on a magnitude m=\sqrt{(x\hat{ })²+(y\hat{ })²+z²} calculated based on

$$x \hat{}= tan ( {tan}^{- 1} ( \frac{x}{z} ) * {{c}^{′}}_{x} ) and y \hat{}= tan ( {tan}^{- 1} ( \frac{y}{z} ) * {{c}^{′}}_{y} ) ,$$

where (x, y, z) is the previously determined eye gaze of the user that the calibration indicator 612 is aligned with. The application 604 may adjust how the calibration indicator 612 is displayed based on the adjustment at 616, and may output the new indicator of the calibration indicator 612 to the display 606 based on the adjustment at 616 for further feedback. The user may provide further calibration feedback that is received by the CPU 602, which may transmit an indicator of the calibration feedback 614 to the application 604 for further refinement. Eventually, the user may indicate via the UI that the displayed calibration indicator is aligned with the user's gaze.

In some aspects, the user may provide a signal via the UI that the displayed calibration indicator is aligned with the user's gaze, for example by tapping a button associated with calibration verification or by saying a phrase such as “calibration verified.” In response, the CPU 602 may transmit a confirmation indicator 618 to the application 604. The application 604 may receive the confirmation indicator 618. At 620, the application 604 may confirm the eye gaze calibration is complete, and may calculate future eye gaze directions based on the error correction indicator received from the user. In other aspects, the user may provide a signal via the UI that the displayed calibration indicator is aligned with the user's gaze by not providing any calibration feedback 614 for a threshold period of time. At 620, the application 604 may determine that an update to the calibration feedback 614 has not been received for at least a threshold amount of time. In response, the application 604 may confirm the eye gaze calibration is complete, and may calculate future eye gaze directions based on the calibration feedback received from the user.

In some aspects, the application 604 may continue to calculate future eye gaze directions based on the calibration feedback, but may not adjust the system eye gaze calibration. In other words, the eye gaze calibration performed for the application 604 may not be used by other applications of the system, or by the system itself. The calibration may be applied to displays of images by the application 604 and no other programs for the device (e.g., an HMD).

In other aspects, the application 604 may be configured to provide feedback to the system to adjust the system's calibration for the eye-focus data. The application 604 may provide an indication of the calibration feedback 624 to the CPU 602, such as an error correction indicator (cₓ′, c_{y}′) based on the set of eye focus data 608 (e.g., (x, y, z) coordinates). At 626, the CPU 602 may adjust its calibration of the user's eye gaze based on the indication of the calibration feedback 624. In response to transmitting the indication of the calibration feedback 624, the application 604 may disable the eye gaze calibration adjustments at 620, and may instead base its display on eye focus data received from the CPU 602, such as the set of eye focus data 608. In other aspects, the CPU 602 may transmit a calibration indicator 628 to the application 604 in response to calibrating its eye gaze based on the calibration feedback 624. The application 604 may receive the calibration indicator 628 from the CPU 602. In response to receiving the calibration indicator 628, the application 604 may disable the eye gaze calibration adjustments at 620, and may instead base its display on eye focus data received from the CPU 602, such as the set of eye focus data 608.

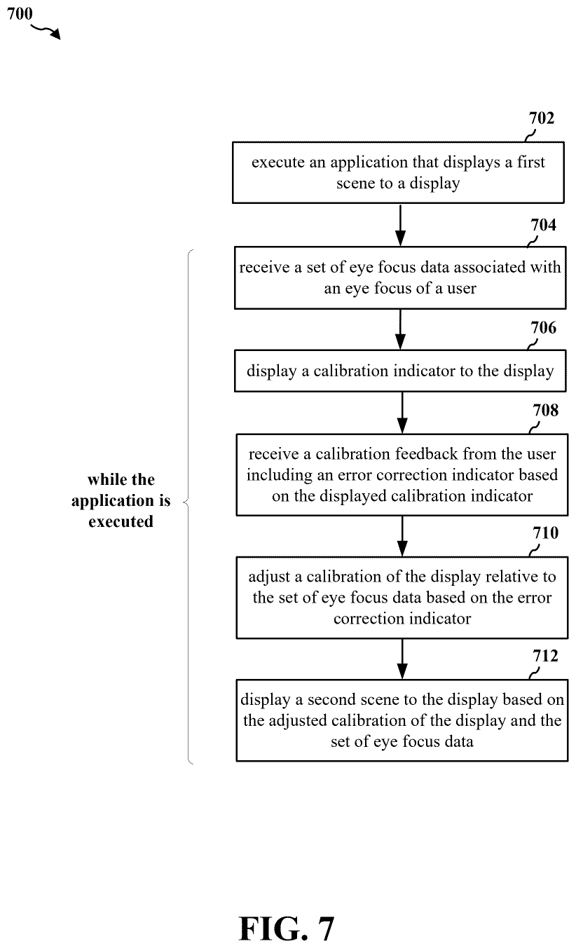

FIG. 7 is a flowchart 700 of an example method of display processing in accordance with one or more techniques of this disclosure. The method may be performed by an apparatus, such as an apparatus for display processing, a GPU, a CPU, a display processing unit (DPU) or other display processor, a wireless communication device, and the like, as used in connection with the aspects of FIGS. 1-6.

At 702, the apparatus may execute an application that displays a first scene to a display. For example, 702 may be performed by the CPU 602 in FIG. 6, which may execute an application 604 that displays a scene to a display 606. In another aspect, 702 may be performed by the processing unit 120 in FIG. 6, which may execute an application that outputs display indicators to the display processor 127 for displaying a scene to a set of displays 131. Moreover, 702 may be performed by the display calibration adjuster 198 in FIG. 1.

At 704, the apparatus may, while the application is executed, receive a set of eye focus data associated with an eye focus of a user. For example, 704 may be performed by the application 604 in FIG. 6, which may receive an indication of the set of eye focus data 608 associated with an eye focus of a user. Moreover, 704 may be performed by the display calibration adjuster 198 in FIG. 1.

At 706, the apparatus may, while the application is executed, display a calibration indicator to the display. For example, 706 may be performed by the application 604 in FIG. 6, which may transmit a calibration indicator 612 to the display 606. Moreover, 706 may be performed by the display calibration adjuster 198 in FIG. 1.

At 708, the apparatus may, while the application is executed, receive a calibration feedback from the user including an error correction indicator based on the displayed calibration indicator. For example, 708 may be performed by the application 604 in FIG. 6, which may receive an indication of calibration feedback 614 from the CPU 602. The calibration feedback 614 may include an error correction indicator based on the calibration indicator 612 displayed by the display 606. Moreover, 708 may be performed by the display calibration adjuster 198 in FIG. 1.

At 710, the apparatus may, while the application is executed, adjust a calibration of the display relative to the set of eye focus data based on the error correction indicator. For example, 710 may be performed by the application 604 in FIG. 6, which may, at 616, adjust a calibration of the display 606 relative to the set of eye focus data 608 based on the error correction indicator of the calibration feedback 614. Moreover, 710 may be performed by the display calibration adjuster 198 in FIG. 1.

At 712, the apparatus may, while the application is executed, display a second scene to the display based on the adjusted calibration of the display and the set of eye focus data. For example, 712 may be performed by the application 604 in FIG. 6, which may display a second scene to the display 606 by transmitting the calibration indicator 612 based on the adjustment at 616. Moreover, 712 may be performed by the display calibration adjuster 198 in FIG. 1.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for executing an application that displays a first scene to a display. The apparatus may further include means for, while the application is executed, receiving a set of eye focus data associated with an eye focus of a user. The apparatus may further include means for, while the application is executed, displaying a calibration indicator to the display. The apparatus may further include means for, while the application is executed, receiving a calibration feedback from the user including an error correction indicator based on the displayed calibration indicator. The apparatus may further include means for, while the application is executed, adjusting a calibration of the display relative to the set of eye focus data based on the error correction indicator. The apparatus may further include means for, while the application is executed, displaying a second scene to the display based on the adjusted calibration of the display and the set of eye focus data. The apparatus may further include means for, while the application is executed, receiving the set of eye focus data by receiving a set of sensor data from a set of sensors monitoring the user. The set of sensors may include at least one of: a head pose sensor; and an eye focus sensor. The apparatus may further include means for, while the application is executed, estimating the eye focus based on the set of eye focus data. The first scene may include an outer quad (OQ) area and an inner quad (IQ) area. The IQ area may have a higher pixel per degree (PPD) than the OQ area. The apparatus may further include means for, while the application is executed, displaying the calibration indicator to the display by centering the IQ area on the eye focus based on the set of eye focus data. The OQ area may have a wider field of view (FOV) than the IQ area. The error correction indicator may include a vertical scale factor from the user and a horizontal scale factor from the user. The apparatus may further include means for, while the application is executed, adjusting the calibration of the display relative to the set of eye focus data based on the error correction indicator by: (a) determining a modified horizontal direction based on the horizontal scale factor; (b) determining a modified vertical direction based on the vertical scale factor; and (c) determining an adjusted eye focus based on the determined modified horizontal direction and the determined modified vertical direction. The apparatus may further include means for, while the application is executed, adjusting the calibration of the display relative to the set of eye focus data based on the error correction indicator by normalizing the adjusted eye focus further to have a unit norm based on the determined modified horizontal direction and the determined modified vertical direction. The second scene may include an outer quad (OQ) area and an inner quad (IQ) area. The IQ area may have a higher pixel per degree (PPD) than the OQ area. The apparatus may further include means for, while the application is executed, displaying the second scene to the display based on the adjusted calibration of the display and the set of eye focus data by centering the IQ area on the determined adjusted eye focus. The apparatus may further include means for, while the application is executed, outputting a first indication of the adjusted calibration of the display to a system calibration engine. The apparatus may further include means for, while the application is executed, receiving a second indication that the system calibration engine received the first indication. The apparatus may further include means for, while the application is executed, resetting an adjustment of the calibration of the display in response to a reception of the second indication. The apparatus may further include means for, while the application is executed, receiving a calibration verification indicator from the user. The apparatus may further include means for, while the application is executed, outputting the first indication of the adjusted calibration of the display to the system calibration engine by outputting the first indication of the adjusted calibration of the display to the system calibration engine in response to a second reception of the calibration verification indicator. The apparatus may further include means for, while the application is executed, determining that an update to the calibration feedback has not been received for at least a threshold amount of time. The apparatus may further include means for, while the application is executed, outputting the first indication of the adjusted calibration of the display to the system calibration engine by outputting the first indication of the adjusted calibration of the display to the system calibration engine in response to a determination that the update to the calibration feedback has not been received for at least the threshold amount of time.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: executing an application that displays a first scene to a display, wherein, while the application is executed, the method further comprises: receiving a set of eye focus data associated with an eye focus of a user; displaying a calibration indicator to the display; receiving a calibration feedback from the user comprising an error correction indicator based on the displayed calibration indicator; adjusting a calibration of the display relative to the set of eye focus data based on the error correction indicator; and displaying a second scene to the display based on the adjusted calibration of the display and the set of eye focus data.

Aspect 2 is the method of aspect 1, wherein receiving the set of eye focus data comprises receiving a set of sensor data from a set of sensors monitoring the user.

Aspect 3 is the method of aspect 2, wherein the set of sensors comprises at least one of: a head pose sensor; and an eye focus sensor.

Aspect 4 is the method of any of aspects 1 to 3, further comprising estimating the eye focus based on the set of eye focus data.

Aspect 5 is the method of aspect 4, wherein the first scene comprises an outer quad (OQ) area and an inner quad (IQ) area, wherein the IQ area has a higher pixel per degree (PPD) than the OQ area, wherein displaying the calibration indicator to the display comprises centering the IQ area on the eye focus based on the set of eye focus data.

Aspect 6 is the method of aspect 5, wherein the OQ area has a wider field of view (FOV) than the IQ area.

Aspect 7 is the method of any of aspects 1 to 6, wherein the error correction indicator comprises a vertical scale factor from the user and a horizontal scale factor from the user.

Aspect 8 is the method of aspect 7, wherein adjusting the calibration of the display relative to the set of eye focus data based on the error correction indicator comprises: determining a modified horizontal direction based on the horizontal scale factor; determining a modified vertical direction based on the vertical scale factor; and determining an adjusted eye focus based on the determined modified horizontal direction and the determined modified vertical direction.

Aspect 9 is the method of aspect 8, wherein adjusting the calibration of the display relative to the set of eye focus data based on the error correction indicator further comprises: normalizing the adjusted eye focus further to have a unit norm based on the determined modified horizontal direction and the determined modified vertical direction. For example, the method may calculate the magnitude m=\sqrt{(x\hat{ })²+(y\hat{ })²+z²}, which may be used to normalize the direction vector such that the magnitude of the adjusted eye focus direction is 1. For example, the method may determine the adjusted eye focus as

$${x}^{′} = \frac{x \hat{}}{m} , {y}^{′} = \frac{y \hat{}}{m} , {z}^{′} = \frac{z}{m} .$$

Aspect 10 is the method of either of aspects 8 or 9, wherein the second scene comprises an outer quad (OQ) area and an inner quad (IQ) area, wherein the IQ area has a higher pixel per degree (PPD) than the OQ area, wherein displaying the second scene to the display based on the adjusted calibration of the display and the set of eye focus data comprises centering the IQ area on the determined adjusted eye focus.

Aspect 11 is the method of any of aspects 1 to 10, further comprising: outputting a first indication of the adjusted calibration of the display to a system calibration engine; receiving a second indication that the system calibration engine received the first indication; and resetting an adjustment of the calibration of the display in response to a reception of the second indication.

Aspect 12 is the method of aspect 11, further comprising: receiving a calibration verification indicator from the user, wherein outputting the first indication of the adjusted calibration of the display to the system calibration engine comprises outputting the first indication of the adjusted calibration of the display to the system calibration engine in response to a second reception of the calibration verification indicator.

Aspect 13 is the method of aspect 11, further comprising: determining that an update to the calibration feedback has not been received for at least a threshold amount of time, wherein outputting the first indication of the adjusted calibration of the display to the system calibration engine comprises outputting the first indication of the adjusted calibration of the display to the system calibration engine in response to a determination that the update to the calibration feedback has not been received for at least the threshold amount of time.

Aspect 14 is an apparatus for display processing comprising a processor coupled to a memory and, based on information stored in the memory, the processor is configured to implement a method as in any of aspects 1-13.

Aspect 15 may be combined with aspect 14 and comprises that the apparatus is a wireless communication device.

Aspect 16 may be combined with aspect 15 and further comprises a transceiver or an antenna coupled to the processor, wherein to receive the set of eye focus data associated with the eye focus of the user, the processor is configured to receive, via the transceiver or the antenna, the set of eye focus data associated with the eye focus of the user.

Aspect 17 is an apparatus for display processing comprising means for implementing a method as in any of aspects 1-13.

Aspect 18 is a computer-readable medium (e.g., a non-transitory computer readable-medium) storing computer executable code, the computer executable code, when executed by a processor, causes the processor to implement a method as in any of aspects 1-13.

Various aspects have been described herein. These and other aspects are within the scope of the following claims.

What is claimed is:

1. An apparatus for display processing, comprising:
a memory; and
a processor coupled to the memory and, based at least in part on information stored in the memory, the processor is configured to:
execute an application that displays a first scene to a display, wherein, while the application is executed, the processor is further configured to:
receive a set of eye focus data associated with an eye focus of a user;
display a calibration indicator to the display;
receive a calibration feedback from the user comprising an error correction indicator based on the displayed calibration indicator;
adjust a calibration of the display relative to the set of eye focus data based on the error correction indicator; and
display a second scene to the display based on the adjusted calibration of the display and the set of eye focus data.

2. The apparatus of claim 1, wherein, to receive the set of eye focus data, the processor is configured to:
receive a set of sensor data from a set of sensors monitoring the user.

3. The apparatus of claim 2, wherein the set of sensors comprises at least one of:
a head pose sensor; and
an eye focus sensor.

4. The apparatus of claim 1, wherein the processor is further configured to:
estimate the eye focus based on the set of eye focus data.

5. The apparatus of claim 1, wherein the first scene comprises an outer quad (OQ) area and an inner quad (IQ) area, wherein the IQ area has a higher pixel per degree (PPD) than the OQ area, wherein, to display the calibration indicator to the display, the processor is configured to:
center the IQ area on the eye focus based on the set of eye focus data.

6. The apparatus of claim 5, wherein the OQ area has a wider field of view (FOV) than the IQ area.

7. The apparatus of claim 1, wherein the error correction indicator comprises a vertical scale factor and a horizontal scale factor.

8. The apparatus of claim 7, wherein, to adjust the calibration of the display relative to the set of eye focus data based on the error correction indicator, the processor is configured to:
determine a modified horizontal direction based on the horizontal scale factor;
determine a modified vertical direction based on the vertical scale factor; and
determine an adjusted eye focus based on the determined modified horizontal direction and the determined modified vertical direction.

9. The apparatus of claim 8, wherein, to adjust the calibration of the display relative to the set of eye focus data based on the error correction indicator, the processor is further configured to:
normalize the adjusted eye focus further to have a unit norm based on the determined modified horizontal direction and the determined modified vertical direction.

10. The apparatus of claim 8, wherein the second scene comprises an outer quad (OQ) area and an inner quad (IQ) area, wherein the IQ area has a higher pixel per degree (PPD) than the OQ area, wherein, to display the second scene to the display based on the adjusted calibration of the display and the set of eye focus data, the processor is configured to:
center the IQ area on the determined adjusted eye focus.

11. The apparatus of claim 1, wherein the apparatus comprises a wireless communication device.

12. The apparatus of claim 1, wherein the processor is further configured to:
output a first indication of the adjusted calibration of the display to a system calibration engine;
receive a second indication that the system calibration engine received the first indication; and
reset an adjustment of the calibration of the display in response to a reception of the second indication.

13. The apparatus of claim 12, wherein the processor is further configured to:
receive a calibration verification indicator from the user, wherein, to output the first indication of the adjusted calibration of the display to the system calibration engine, the processor is configured to:
output the first indication of the adjusted calibration of the display to the system calibration engine in response to a second reception of the calibration verification indicator.

14. The apparatus of claim 12, wherein the processor is further configured to:
determine that an update to the calibration feedback has not been received for at least a threshold amount of time, wherein, to output the first indication of the adjusted calibration of the display to the system calibration engine, the processor is configured to:
output the first indication of the adjusted calibration of the display to the system calibration engine in response to a determination that the update to the calibration feedback has not been received for at least the threshold amount of time.

15. A method of display processing, comprising:
executing an application that displays a first scene to a display, wherein, while the application is executed, the method further comprises:
receiving a set of eye focus data associated with an eye focus of a user;
displaying a calibration indicator to the display;
receiving a calibration feedback from the user comprising an error correction indicator based on the displayed calibration indicator;
adjusting a calibration of the display relative to the set of eye focus data based on the error correction indicator; and
displaying a second scene to the display based on the adjusted calibration of the display and the set of eye focus data.

16. The method of claim 15, wherein the first scene comprises an outer quad (OQ) area and an inner quad (IQ) area, wherein the IQ area has a higher pixel per degree (PPD) than the OQ area, wherein displaying the calibration indicator to the display comprises:
centering the IQ area on the eye focus based on the set of eye focus data.

17. The method of claim 16, wherein the OQ area has a wider field of view (FOV) than the IQ area, wherein the error correction indicator comprises a vertical scale factor from the user and a horizontal scale factor, wherein adjusting the calibration of the display relative to the set of eye focus data based on the error correction indicator comprises:
determining a modified horizontal direction based on the horizontal scale factor;
determining a modified vertical direction based on the vertical scale factor; and
determining an adjusted eye focus based on the determined modified horizontal direction and the determined modified vertical direction.

18. The method of claim 17, wherein adjusting the calibration of the display relative to the set of eye focus data based on the error correction indicator further comprises:
normalizing the adjusted eye focus further to have a unit norm based on the determined modified horizontal direction and the determined modified vertical direction.

19. The method of claim 17, wherein the second scene comprises an outer quad (OQ) area and an inner quad (IQ) area, wherein the IQ area has a higher pixel per degree (PPD) than the OQ area, wherein displaying the second scene to the display based on the adjusted calibration of the display and the set of eye focus data comprises:
centering the IQ area on the determined adjusted eye focus.

20. A computer-readable medium storing computer executable code, the code, when executed by a processor, causes the processor to:
execute an application that displays a first scene to a display, wherein, while the application is executed, the code, when executed by the processor, causes the processor to:
receive a set of eye focus data associated with an eye focus of a user;
display a calibration indicator to the display;
receive a calibration feedback from the user comprising an error correction indicator based on the displayed calibration indicator;
adjust a calibration of the display relative to the set of eye focus data based on the error correction indicator; and
display a second scene to the display based on the adjusted calibration of the display and the set of eye focus data.
